(19) United States
(12) Patent Application Publication
(10) Pub. No.: US 2020/0285815 A1
(43) Pub. Date: Sep. 10, 2020

(54) SPEECH TRANSLATION TERMINAL, MOBILE TERMINAL, TRANSLATION SYSTEM, TRANSLATION METHOD, AND TRANSLATION DEVICE

(71) Applicant: BEIJING KINGSOFT INTERNET SECURITY SOFTWARE CO., LTD., Beijing (CN)

(72) Inventor: Lu Zhou, Beijing (CN)

(73) Assignee: BEIJING KINGSOFT INTERNET SECURITY SOFTWARE CO., LTD., Beijing (CN)

(21) Appl. No.: 16/801,342

(22) Filed: Feb. 26, 2020

(30) Foreign Application Priority Data
Mar. 7, 2019 (CN) 201910173337.5
Mar. 7, 2019 (CN) 201920294227.X

(51) Int. Cl. G06F 40/58; G10L 15/26; H04R 3/00; G10L 15/00

(52) U.S. Cl. CPC G06F 40/58; G10L 15/005; H04R 3/005; G10L 15/26

(57) ABSTRACT

The present disclosure provides a speech translation terminal, a mobile terminal, a translation system, a translation method, and a translation device. The speech translation terminal includes a controller, a trigger button, a microphone set, a speaker, and a communication component. The trigger button is electrically coupled to the controller. The microphone set is electrically coupled to the controller, and configured to acquire first speech information after the trigger button is triggered. The speaker is electrically coupled to the controller, and configured to play second speech information under control of the controller. The second speech information is speech information translated from the first speech information. The controller is electrically coupled to the communication component, and configured to control the communication component to send the first speech information to a mobile terminal and receive the second speech information sent by the mobile terminal.

### CROSS-REFERENCE TO RELATED APPLICATIONS

This application claims priority to and benefits of Chinese Patent Application No. 201910173337.5, filed with the National Intellectual Property Administration of P. R. China on Mar. 7, 2019, and Chinese Patent Application No. 201920294227. X, filed with the National Intellectual Property Administration of P. R, China on Mar. 7, 2019, the entire contents of which are incorporated herein by reference.

### TECHNICAL FIELD

The present disclosure relates to the field of speech recognition technologies, and more particular to, a speech translation terminal, a mobile terminal, a translation system, a translation method, and a translation device.

### BACKGROUND

With the rapid development of the economy and the increasing frequency of international exchanges, users may have the need to use two or more languages. Currently, the speech translation terminal, with its powerful language translation function, is well received among users with language translation requirements. By using a speech translation terminal for translation during a dialogue, users speaking different languages can communicate freely.

### SUMMARY

Embodiments of the present disclosure provide a speech translation terminal. The speech translation terminal includes a controller, a trigger button, a microphone set, a speaker, and a communication component.

The trigger button is electrically coupled to the controller. The microphone set is electrically coupled to the controller, and configured to acquire first speech information after the trigger button is triggered. The speaker is electrically coupled to the controller, and configured to play second speech information under control of the controller. The second speech information is speech information translated from the first speech information. The controller is electrically coupled to the communication component, and configured to control the communication component to send the first speech information to a mobile terminal and receive the second speech information sent by the mobile terminal.

Embodiments of the present disclosure provide a mobile terminal, including a mobile communication component, and a mobile processor. The mobile communication component is electrically coupled to the mobile processor, and configured to communicate with a speech translation terminal and a server. The mobile communication component is configured to receive first speech information sent by the speech translation terminal, and send the first speech information preprocessed by the mobile processor to the server, such that the server translates the preprocessed first speech information to obtain second speech information according to a translation setting of the mobile processor. The mobile communication component is further configured to receive the second speech information sent by the server, and send the second speech information to the speech translation terminal. The mobile processor is configured to preprocess the first speech information. The mobile processor is further configured to generate translation setting information, and send the translation setting information to the server through the mobile communication component, such that the server determines a corresponding translation setting according to the translation setting information, and translates the preprocessed first speech information based on the translation setting to obtain the second speech information.

Embodiments of the present disclosure further provide a translation method, which is applicable to a speech translation terminal. The speech translation terminal is configured to communicate with a mobile terminal. The method includes: acquiring first speech information; sending the first speech information to the mobile terminal, and receiving second speech information sent by the mobile terminal; and playing the second speech information. The second speech information is speech information translated from the first speech information.

Additional aspects and advantages of the present application will be given in the following description, some of which will become apparent from the following description or be learned from practices of the present application.

### BRIEF DESCRIPTION OF THE DRAWINGS

The above and/or additional aspects and advantages of the present disclosure will become apparent and readily understood from the following description of the embodiments, in which:

FIG. 1 is a schematic diagram of a speech translation terminal according to embodiment one of the present disclosure.

FIG. 2 is a schematic diagram of a product shape of a speech translation terminal according to embodiment two of the present disclosure.

FIG. 3 is a schematic diagram of a speech translation terminal according to embodiment three of the present disclosure.

FIG. 4 is a schematic diagram of a translation process according to embodiment four of the present disclosure.

FIG. 5 is a schematic diagram of a mobile terminal according to embodiment five of the present disclosure.

FIG. 6 is a schematic diagram of a translation system according to embodiment six of the present disclosure.

FIG. 7 is a flow chart of a translation method according to embodiment seven of the present disclosure.

FIG. 8 is a flow chart of a translation method according to embodiment eight of the present disclosure.

FIG. 9 is a block diagram of a translation device according to embodiment nine of the present disclosure.

FIG. 10 is a block diagram of a translation device according to embodiment ten of the present disclosure.

FIG. 11 is a block diagram of a translation device according to embodiment eleven of the present disclosure.

### DETAILED DESCRIPTION

Embodiments of the present disclosure will be described in detail, and examples of embodiments are illustrated in the drawings. The same or similar elements and the elements having the same or similar functions are denoted by like reference numerals throughout the descriptions. Embodiments described herein with reference to drawings are explanatory, serve to explain the present disclosure, and are not construed to limit embodiments of the present disclosure.

The speech translation terminal can realize translation from a specified language (such as English) to a specified target language (such as Chinese). Thus, there are at least two buttons on the speech translation terminal, one for determining the language spoken by the user, and another for triggering speech data acquisition. When the user uses the speech translation terminal for translation, the language spoken by the user can be automatically translated into another language.

However, when the user uses the speech translation terminal for translation, he/she needs to press two buttons one after another, the operation steps are cumbersome.

Embodiments of the present disclosure provide a speech translation terminal, a mobile terminal, a translation system, a translation method, and a translation device according to embodiments of the present disclosure, which will be described below with reference to the drawings.

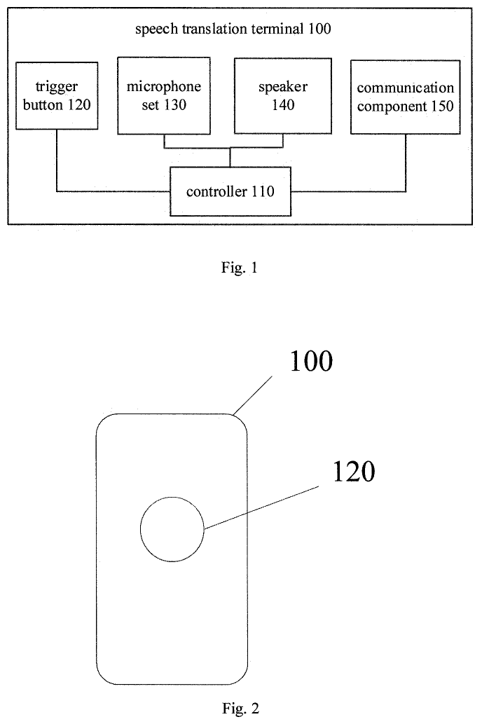

FIG. 1 is a schematic diagram of a speech translation terminal according to embodiment one of the present disclosure. As illustrated in FIG. 1, the speech translation terminal 100 may include a controller 110, a trigger button 120, a microphone set 130, a speaker 140, and a communication component 150.

The trigger button 120 is electrically coupled to the controller 110.

In an embodiment of the present disclosure, the speech translation terminal 100 is provided with only one trigger button 120, and the user can input speech data by triggering the trigger button 120. When the speech translation terminal 100 detects, by listening, that the trigger button 120 is triggered by the user, it may acquire first speech information through the microphone set 130.

In an embodiment, FIG. 2 is a schematic diagram of a product shape of a speech translation terminal according to embodiment two of the present disclosure. As illustrated in FIG. 2, the front side of the speech translation terminal 100 may include the trigger button 120. When the user triggers the trigger button 120, the controller may control the microphone set 130 to acquire the first speech information.

It is to be understood that, FIG. 2 merely takes a square shape as an exemplary shape of the speech translation terminal 100. In practical applications, for a better appearance of the speech translation terminal 100, the designer may design the appearance of the speech translation terminal 100 according to practical requirements. For example, it may be designed into a round shape, an elliptical shape, etc., which is not limited.

The microphone set 130 is electrically coupled to the controller 110, and configured to acquire the first speech information after the trigger button 120 is triggered.

In an embodiment of the present disclosure, the microphone set 130 may include at least two microphones. For example, when the microphone set 130 includes two microphones, one may be configured to acquire speech data input by the user, and the other may be configured to acquire noise data. For example, a microphone may be arranged on the front side of the speech translation terminal 100, and configured to acquire the speech data input by the user. It should be understood that, in addition to normal acquisition of user's speech data, there may also be environmental noise around the microphone. The other microphone may be arranged on the rear side of the speech translation terminal 100, and configured to acquire the noise data. It should be understood that, the noise data may also contain a small portion of speech data input by the user. The microphone set 130 may subtract and amplify the speech data and the noise data, thereby obtaining the first speech information. Thus, the first speech information is obtained by noise reduction, the signal quality of the first speech information can be improved, such that the translation accuracy may be increased in subsequent steps of obtaining second speech information through translation.

The speaker 140 is electrically coupled to the controller 110, and configured to play the second speech information according to the control of the controller 110. The second speech information is speech information translated from the first speech information.

The controller 110 is electrically coupled to the communication component 150, and configured to control the communication component 150 to send the first speech information to the mobile terminal, and to control the communication component 150 to receive the second speech information sent by the mobile terminal.

In an embodiment of the present disclosure, the mobile terminal may be a hardware device having various operating systems, a touch screen and/or a display screen, such as a mobile phone, a tablet computer, a personal digital assistant, a wearable device, or the like.

In the embodiment of the present disclosure, the communication component 150 may be, for example, a Bluetooth component, and the speech translation terminal 100 can communicate with the mobile terminal through the communication component 150.

Specifically, the speech translation terminal 100 may communicate with the mobile terminal through the communication component 150, such as a Bluetooth component. After the acquisition of the first speech information, the speech translation terminal 100 may send the first speech information to the mobile terminal through a Bluetooth low energy (BLE) protocol, and then the first speech information may be sent to the server through the mobile terminal. After the server receives the first speech information, the server may translate the first speech information to obtain the second speech information. Then the server may send the second speech information to the mobile terminal, and the mobile terminal may send the second speech information to the speech translation terminal 100 based on the BLE protocol. Correspondingly, the speech translation terminal 100 may play the second speech information through the speaker 140 upon reception of the second speech information.

For example, the speech translation terminal 100 may be connected to the mobile terminal through Bluetooth in advance, and start a translation application (APP) such as a CM translation APP in the mobile terminal. After the acquisition of the first speech information, the speech translation terminal 100 may send the first speech information to the mobile terminal through the BLE protocol, and the translation APP in the mobile terminal may send the first speech information to the server via the network. When the server receives the first speech information, it may translate the first speech information to obtain the second speech information, and then the server may send the second speech information to the mobile terminal via the network. The translation APP in the mobile terminal may send the second speech information to the speech translation terminal 100 based on the BLE protocol. Correspondingly, the speech translation terminal 100 may play the second speech information through the speaker 140 upon the reception of the second speech information.

In the embodiment of the present disclosure, the server may translate the first speech information into the second speech information according to the translation setting of the mobile terminal. The translation setting may be determined based on translation setting information input by the user.

Specifically, the user may set the translation setting information in the mobile terminal. For example, the user may set the translation setting information in the translation APP of the mobile terminal, after the translation setting information is set, the mobile terminal may send the translation setting information to the server, and the server may determine, according to the translation setting information set by the user, the corresponding translation setting.

In an implementation, the translation setting information may include settings of mutual translation between the first language and the second language. In this case, the translation setting may include a setting that the first language and the second language are mutually translated into one another. The server may recognize the language of the first speech information, when the language of the first speech information is the first language, the server may translate it into second speech information of the second language, and when the language of the first speech information is the second language, the server may translate it into second speech information of the first language. Thus, the server can automatically recognize the language spoken by the user, and translate it into corresponding speech information of the other language, it is unnecessary to set a corresponding button on the speech translation device 100 to determine the language spoken by the user, thereby simplifying the user's operations, and improving the user experience.

The translation setting may include mutual translation between Chinese and English, mutual translation between Chinese and French, mutual translation between English and German, etc. For example, when the translation setting is the mutual translation between Chinese and English, the first language may be Chinese, and the second language may be English, or the first language may be English, and the second language may be Chinese.

Taking the translation setting of mutual translation between Chinese and English as an example, when the user uses the speech translation terminal 100 for translation, when the user speaks English after the trigger button 120 is pressed, the speech translation terminal 100 may play Chinese after the trigger button 120 is released, and when the user speaks Chinese after the trigger button 120 is pressed, the speech translation terminal 100 may play English after the trigger button 120 is released. Thus, regardless of whether the user speaks Chinese or English, the speech translation terminal will translate it into the other corresponding speech, thereby realizing automatic translation between two languages, which is convenient for the user.

In another alternative implementation, the translation setting information may include settings of translation from the first language to the second language. In this case, the translation setting may include the setting that the first language is translated into the second language, and the server may translate the first speech information of the first language into second speech information of the second language. The translation setting may include translation from Chinese to English, translation from English to Chinese, translation from Chinese to French, translation from Chinese to German, etc. For example, when the translation setting is the translation from Chinese to English, the first language may be Chinese, and the second language may be English.

Taking the translation setting of the translation from Chinese to English as an example, when the user uses the speech translation terminal 100 for translation, and the user speaks Chinese after the trigger button 120 is pressed, the speech translation terminal 100 may play English after the trigger 120 is released. Thus, the language spoken by the user can be automatically translated into the other language, which is convenient for the user. In the embodiment of the present disclosure, the speech translation terminal 100 acquires the first speech information through the microphone set 130, and sends the first speech information to the mobile terminal through the communication component 150, and receives the second speech information sent by the mobile terminal. The first speech information is transmitted to the server through the mobile terminal, and is translated by the server to obtain the second speech information. The server sends the second speech information to the speech translation terminal 100 through the mobile terminal, and the speech translation terminal 100 plays the second speech information through the speaker. Thus, there is no need to arrange a corresponding button on the speech translation terminal to determine the language of the first speech information, and the user merely needs to trigger the only trigger button to acquire the first speech information, such that the first speech information can be automatically translated into another language, thereby simplifying the user's operations, and improving the user experience.

It should be noted that, when the server translates the first speech information into the second speech information according to the translation setting, the server may recognize the first speech information as text information, translate the text information, and synthesize it into the corresponding second speech information. Specifically, the server may recognize the first speech information to acquire the language of the first speech information, and convert the first speech information into a text file according to the language of the first speech information. Then, the server may determine a target language according to the language corresponding to the first speech information and a translation mode, and translate the text file into a translation file of the target language, and generate second speech information based on the translation file. For example, the file in the text format may be converted into speech information in the speech format.

It may be understood that, different languages may have different phoneme arrangement, that is, pronouncing phones, strings of phones, and the relationship between the appearance frequency of the phone and the context are different. Therefore, the languages may be distinguished based on the above characteristics.

In an alternative implementation, the server may be provided with a trained language recognition model, and the language of the first speech information can be recognized based on the trained language recognition model.

In another alternative implementation, a plurality of speech samples may be acquired in advance, and the language corresponding to each of the plurality of speech samples may be marked. After the server acquires the first speech information, the server may match the first speech information with the above speech samples, determine a speech sample having a matching degree higher than a preset threshold, and take the language of the determined speech sample as the language of the first speech information. The preset threshold may be preset, which may be, for example, 95%.

In the embodiment of the present disclosure, after the server recognizes the language of the first speech information, it may convert the first speech information into a text file according to speech recognition technology in the related art. Then, the server may determine a target language according to the language corresponding to the first speech information and the translation mode, and translate the text file into a translation file of the target language. For example, when the language corresponding to the first speech information is the first language, the target language is the second language, or the language corresponding to the first speech information is the second language, the target language is the first language, the server may translate the text file into the translation file of the target language based on a translation rule between the language of the first speech information and the target language, and then synthesize the translation file into the second speech information.

For example, when the target language is English, the server may perform a conversion from letters to phones (or syllables) on the translation file, to synthesize and obtain the second voice information. When the target language is Chinese, the server may perform a conversion from Chinese characters to phones (or pinyin) on the translation file, to synthesize and obtain the second voice information.

In the embodiment of the present disclosure, the first speech information is recognized as text information, and the text information is translated and synthesized into the corresponding second speech information, such that the accuracy of the translation can be improved.

In an alternative implementation, after the mobile terminal receives the first speech information, the mobile terminal may preprocess the first speech information, and send the preprocessed first speech information to the server. Correspondingly, upon the reception of the preprocessed first speech information, the server may translate the preprocessed first speech information according to the translation setting of the mobile terminal, so as to obtain the second speech information. Then, the server may send the second speech information to the mobile terminal, and the mobile terminal may send the second speech information to the speech translation device 100 after the second speech information is received. Correspondingly, the speech translation terminal 100 may receive the second speech information sent by the mobile terminal through the communication component 150.

In the process of acquiring the speech and generating the speech file, it may be understood that, the speech translation terminal 100 may generate a header, a trailer and the like of the speech file, and send a complete speech file of the first speech information to the mobile terminal. The mobile terminal may perform an integrity check on the first speech information upon reception of the first speech information, to determine whether the first speech information is complete. When the first speech information is not complete, the mobile terminal may send feedback to the speech translation terminal 100, to cause the speech translation terminal 100 to resend the first speech information. When the first speech information is complete, the mobile terminal may decode the first speech information, and send the decoded first speech information to the server.

Specifically, the mobile terminal may decode the first speech information based on the speech file format supported by the server. For example, for a Microsoft server, its supported speech file format is a MP3 format, the first speech information may be decoded into the speech file of the MP3 format, and the decoded first speech information may be sent to the Microsoft server, such that the Microsoft server translates the first speech information according to the its supported format, to obtain the second speech information.

In the embodiment of the present disclosure, by decoding the first speech information according to the speech file format supported by the server, the server can perform normal translation of the first speech information.

In an embodiment, the speech translation terminal 100 may include a housing (not shown), and the controller 110, the microphone set 130, the speaker 140 and the communication component 150 are arranged in a space formed by the housing. As an alternative implementation, on the basis of embodiments shown in FIG. 1, the housing may include a first housing and a second housing matched with each other. The first housing may include a light emitting diode (LED) and a trigger button 120.

The on or off of the LED may be controlled by a LED control module (or the controller 110), so as to give the user a prompt. For example, when the user presses the trigger button 120, the LED control module (or the controller 110) may control the LED to be turned on to give the user a prompt. When the user does not press the trigger button 120, the LED control module (or the controller 110) may control the LED to be turned off.

The second housing may be provided with the speaker 140, a charging slot and the microphone set 130. The communication component 150, a power module and an access module are arranged between the first housing and the second housing.

In the embodiment of the present disclosure, to improve the translation accuracy, the first speech information after noise reduction may be acquired by the microphone set 130.

The controller 110 is configured to receive the first speech information acquired by the microphone set 130, and compress and packetize the first speech information.

In the embodiment of the present disclosure, in order to guarantee the signal quality of the first speech information, reduce network resource occupation, and improve the translation efficiency, the controller 110 may further compress and packetize the processed first speech information after the first speech information is acquired.

The communication component 150 may be configured to send the compressed and packetized first speech information to the mobile terminal. Correspondingly, the mobile terminal may preprocess the compressed and packetized first speech information upon the reception of the compressed and packetized first speech information, to obtain the preprocessed first speech information. Then, the mobile terminal may send the compressed and packetized first speech information to the server via the network, such that the server may recognize the preprocessed first speech information to acquire the language of the preprocessed first speech information, and translate, according to the translation setting of the mobile terminal and the language of the preprocessed first speech information, the preprocessed first speech information to obtain the second speech information. The server may send the second speech information to the mobile terminal via the network when it obtains the second speech information through translation, and then the mobile terminal may send the second speech information to the speech translation device 100, and the speech translation device 100 may receive the second speech information sent by the mobile terminal through the communication component 150.

The controller 110 is further configured to acquire the second speech information sent by the server through the mobile terminal, and depacketize and decompress the second speech information.

The speaker 140 is configured to play the depacketized and decompressed second speech information.

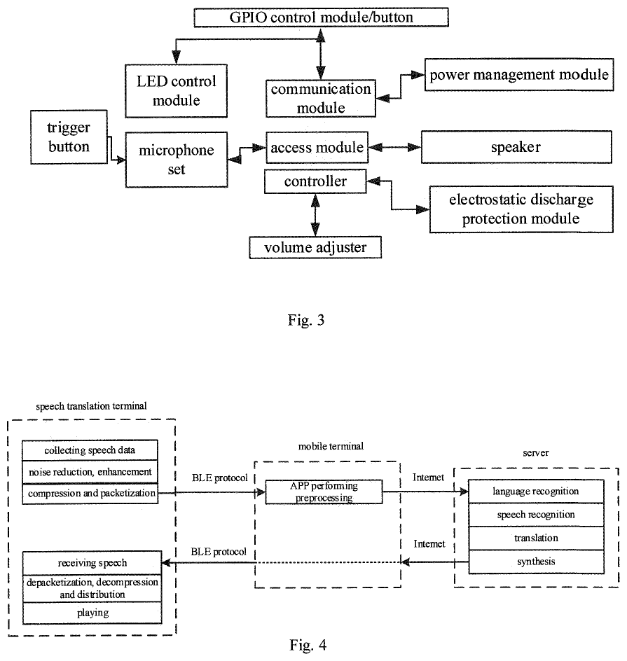

FIG. 3 is a schematic diagram of a speech translation terminal according to embodiment three of the present disclosure. As illustrated in FIG. 3, the speech translation terminal may further include a GPIO (general-purpose input/output) control module/button, a volume adjuster, a power management module, and an electrostatic discharge protection module. For example, the volume adjuster may be configured to adjust the volume of the speech translation terminal, the power management module may be configured to manage the power of the speech translation terminal. For example, as illustrated in FIG. 3, when the user presses the trigger button, the LED control module may control the LED to be turned on. Meanwhile, denoised and enhanced first speech information may be acquired by the microphone set, and the first speech information may be stored by the access module.

The controller may acquire the first speech information from the access module, and compress and packetize the first speech information. Then, the controller may control the communication component to send the compressed and packetized first speech information to the mobile terminal, and the mobile terminal may preprocess the compressed and packetized first speech information to obtain the preprocessed first speech information, and then the mobile terminal may send the preprocessed first speech information to the server.

Upon acquisition of the first speech information, the server may translate, according to the translation setting of the mobile terminal and the language of the preprocessed first speech information, the preprocessed first speech information to obtain the second speech information, and send the second speech information to the speech translation terminal through the mobile terminal. After the speech translation terminal receives the second speech information through the communication component, the speech translation terminal may depacketize and decompress the second speech information by the controller, and control the speaker to play the depacketized and decompressed second speech information.

FIG. 4 is a schematic diagram of a translation process according to embodiment four of the present disclosure. The user may press the trigger button on the speech translation terminal to acquire the speech data. It should be noted that, there is only one trigger button on the speech translation terminal, and regardless of what kind of language the user speaks, the user may simply press the trigger button (the language supported by the speech translation device only needs to be set in the translation APP in the mobile terminal, i.e., the user can set the language he/she speaks and the final translation language in the translation APP). When the user finishes speaking, he/she may release the trigger button.

After the acquisition of the speech data, to improve the accuracy of subsequent translation, the speech data may be denoised and enhanced, to obtain the first speech information. In addition, to guarantee the signal quality of the first speech information, reduce network resource occupation and improve the translation efficiency, in the present disclosure, the speech translation terminal may compress and packetize the first speech information. Then, the speech translation terminal may send the compressed and packetized first speech information based on a transmission protocol such as the BLE protocol to the mobile terminal, the translation APP in the mobile terminal may perform front-end processing (preprocessing) on the compressed and packetized first speech information, and then the preprocessed first speech information may be sent to the server via the network.

After the server receives the preprocessed first speech information, the server may recognize the language of the preprocessed first speech information according to the translation setting of the mobile terminal, and convert the preprocessed first speech information into the text file according to the speech recognition technology. And then, the server may translate the text file into the translation file of the target language, and synthesize the translation file into the second speech information. The server may send the second speech information to the mobile terminal via the network, and the translation APP in the mobile terminal may send the second speech information to the speech translation terminal based on the BLE protocol.

After the speech translation terminal receives the second speech information, the speech translation terminal may depacketize, decompress and distribute the second speech information, and then the depacketized and decompressed second speech information may be played by the speaker.

To implement the above embodiments, the present disclosure further provides a mobile terminal FIG. 5 is a schematic diagram of a mobile terminal according to embodiment five of the present disclosure. As illustrated in FIG. 5, the mobile terminal 300 includes a mobile communication component 310, and a mobile processor 320.

The mobile communication component 310 is electrically coupled to the mobile processor 320, and configured to communicate with a speech translation terminal 100 and a server.

The mobile communication component 310 is configured to receive first speech information sent by the speech translation terminal 100, and send the first speech information preprocessed by the mobile processor 320 to the server, such that the server translates, according to a translation setting of the mobile processor 320, the preprocessed first speech information to obtain second speech information.

The mobile communication component 310 is further configured to receive the second speech information sent by the server, and send the second speech information to the speech translation terminal 100. The mobile processor 320 is configured to preprocess the first speech information. The mobile processor 320 is further configured to generate translation setting information, and send the translation setting information to the server through the mobile communication component 310, such that the server determines a corresponding translation setting according to the translation setting information, and translates the preprocessed first speech information based on the translation setting to obtain the second speech information.

In the embodiment of the present disclosure, the translation setting is determined based on translation setting information input by the user. Specifically, the user may set the translation setting information in the mobile terminal. For example, the user may set the translation setting information in a translation APP of the mobile terminal, after the translation setting information is set, the mobile terminal 300 may send the translation setting information to the server, and the server may determine, according to the translation setting information set by the user, the corresponding translation setting.

As an alternative implementation, the translation setting information may include settings of mutual translation between the first language and the second language. In this case, the translation setting may include a setting that the first language and the second language are mutually translated into one another. The translation setting may include mutual translation between Chinese and English, mutual translation between Chinese and French, mutual translation between English and German, etc. For example, when the translation setting is the mutual translation between Chinese and English, the first language may be Chinese, and the second language may be English, or the first language may be English, and the second language may be Chinese.

In the embodiment of the present disclosure, after the acquisition of the first speech information, the speech translation terminal 100 may send the first speech information to the mobile terminal 300 through the communication component. Correspondingly, the mobile terminal 300 may receive the first speech information through the mobile communication component 310. After the mobile terminal 300 receives the first speech information, the mobile terminal 300 may preprocess the first speech information by the mobile processor 320, and send the preprocessed first speech information to the server through the mobile communication component 310, such that the server may recognize the language of the preprocessed first speech information. When the language of the preprocessed first speech information is the first language, the server may translate it into the second speech information of the second language, and when the language of the preprocessed first speech information is the second language, the server may translate it into second speech information of the first language. Thus, the server can automatically recognize the language spoken by the user, and translate it into corresponding speech information of the other language. Therefore, it is unnecessary to set a corresponding button on the speech translation terminal 100 to determine the language spoken by the user, thereby simplifying the user's operations, and improving the user experience.

As another alternative implementation, the translation setting information may include settings of translation from the first language to the second language. In this case, the translation setting may include the setting that the first language is translated into the second language. The translation setting may include translation from Chinese to English, translation from English to Chinese, translation from Chinese to French, translation from Chinese to German, etc. For example, when the translation setting is the translation from Chinese to English, the first language may be Chinese, and the second language may be English.

In the embodiment of the present disclosure, after the reception of the first speech information, the mobile terminal 300 may preprocess the first speech information, and send the preprocessed first speech information to the server, such that the server can translate the first speech information into the second speech information of the second language.

In the embodiment of the present disclosure, the mobile terminal 300 receives the first speech information sent by the speech translation terminal, preprocesses the first speech information, and sends the preprocessed first speech information to the server, such that the server translates the preprocessed first speech information to obtain the second speech information according to the translation setting of the mobile terminal, after the second speech information is obtained, the server may send the first speech information to the speech translation terminal through the mobile terminal Thus, there is no need to arrange a corresponding button on the speech translation terminal to determine the language of the first speech information, and the user merely needs to trigger the only trigger button to acquire the first speech information, such that the first speech information can be automatically translated into another language, thereby simplifying the user's operations, and improving the user experience.

As an alternative implementation, before the mobile terminal 320 preprocesses the first speech information, it may perform an integrity check on the first speech information to determine the integrity of the first speech information. When the first speech information fails the integrity check, the mobile terminal 300 may send feedback to the speech translation terminal, to cause the speech translation terminal to resend the first speech information. When the first speech information passes the integrity check, the mobile terminal 300 may decode the first speech information.

In the process of acquiring the speech and generating the speech file, it may be understood that, the speech translation terminal 100 may generate a header, a trailer and the like of the speech file, and the final first speech information sent to the mobile terminal 300 should be complete. When mobile terminal 300 receives the first speech information, the mobile terminal 300 may perform an integrity check on the first speech information to determine whether the first speech information is complete. When the first speech information is not complete, the mobile terminal may send feedback to the speech translation terminal 100, to cause the speech translation terminal 100 to resend the first speech information. When the first speech information is complete, the mobile terminal may decode the first speech information, and send the decoded first speech information to the server.

Specifically, the mobile processor 320 may decode the first speech information based on the speech file format supported by the server. For example, for a Microsoft server, its supported speech file format is a MP3 format, the first speech information may be decoded into the speech file of the MP3 format, and the decoded first speech information may be sent to the Microsoft server, such that the Microsoft server translates the first speech information according to the its supported format, to obtain the second speech information.

In the embodiment of the present disclosure, by decoding the first speech information according to the speech file format supported by the server, the server can perform normal translation of the first speech information.

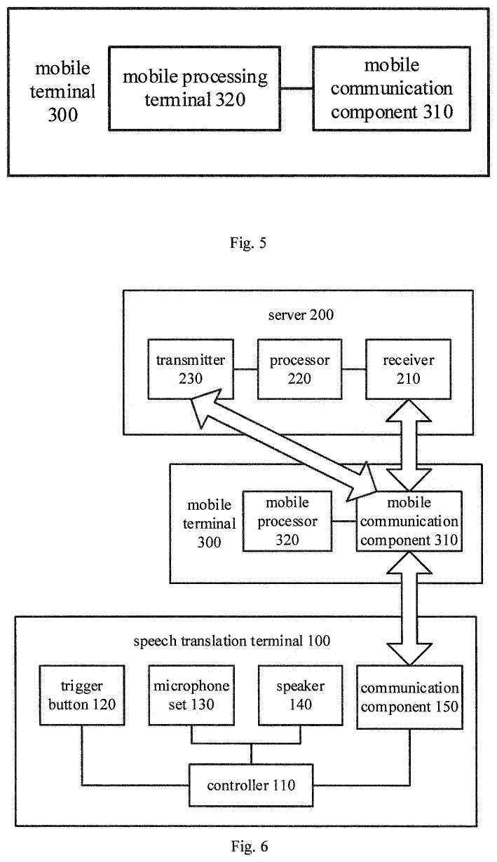

To implement the above embodiments, the present disclosure further provides a translation system. FIG. 6 is a schematic diagram of a translation system according to embodiment six of the present disclosure. As illustrated in FIG. 6, the translation system may include a speech translation terminal 100, a server 200, and a mobile terminal 300.

The speech translation terminal 100 includes a controller 110, a trigger button 120, a microphone set 130, a speaker 140 and a communication component 150. The trigger button 120 is electrically coupled to the controller 110. The microphone set 130 is electrically coupled to the controller 110, and configured to acquire first speech information after the trigger button 120 is triggered. The speaker 140 is electrically coupled to the controller 110, and configured to play second speech information according to the control of the controller 110. The second speech information is speech information translated from the first speech information. The controller 110 is electrically coupled to the communication component 150, and configured to control the communication component 150 to send the first speech information to the mobile terminal 300, and to control the communication component 150 to receive the second speech information sent by the mobile terminal 300.

In the embodiment of the present disclosure, the speech translation terminal 100 is provided with only one trigger button 120, and the user may input speech data by triggering the trigger button 120. For example, as illustrated in FIG. 2, a front side of the speech translation terminal 100 may include the trigger button 120, and the user can input speech data by triggering the trigger button 120. When the speech translation terminal 100 detects, by listening, that the trigger button 120 is triggered by the user, it may acquire first speech information through the microphone set 130.

In an embodiment of the present disclosure, the microphone set 130 may include at least two microphones. For example, when the microphone set 130 includes two microphones, one may be configured to acquire speech data input by the user, and the other may be configured to acquire noise data. For example, a microphone may be arranged on the front side of the speech translation terminal 100, and configured to acquire the speech data input by the user. It should be understood that, in addition to normal acquisition of user's speech data, there may also be environmental noise around the microphone. The other microphone may be arranged on the rear side of the speech translation terminal 100, and configured to acquire the noise data. It should be understood that, the noise data may also contain a small portion of speech data input by the user. The microphone set 130 may subtract and amplify the speech data and the noise data, thereby obtaining the first speech information. Thus, the first speech information is obtained by noise reduction, the signal quality of the first speech information can be improved, such that the translation accuracy may be increased in subsequent steps of obtaining second speech information through translation.

In the embodiment of the present disclosure, the communication component 150 may be, for example, a Bluetooth component, and the speech translation terminal 100 may communicate with the mobile terminal through the communication component 150.

The mobile terminal 300 includes a mobile communication component 310, and a mobile processor 320.

The mobile communication component 310 is electrically coupled to the mobile processor 320, and configured to communicate with a speech translation terminal 100 and a server 200. The mobile communication component 310 is configured to receive the first speech information sent by the speech translation terminal 100, and send the first speech information preprocessed by the mobile processor 320 to the server 200, such that the server 200 translates the preprocessed first speech information to obtain second speech information according to a translation setting of the mobile terminal 300. The mobile communication component 310 is further configured to receive the second speech information sent by the server 200, and send the second speech information to the speech translation terminal 100. The mobile processor 320 is configured to preprocess the first speech information. The mobile processor 320 is further configured to generate translation setting information, and send the translation setting information to the server 200 through the mobile communication component 310, such that the server 200 determines a corresponding translation setting according to the translation setting information, and translate the preprocessed first speech information based on the translation setting to obtain the second speech information.

The server 200 includes a receiver 210, a processor 220, and a transmitter 220. The receiver 210 is configured to acquire the preprocessed first speech information from the mobile terminal 300. The processor 220 is configured to translate the preprocessed first speech information into the second speech information according to the translation setting of the mobile terminal 300. The transmitter 230 is configured to send the second speech information to the mobile terminal 300.

In the embodiment of the present disclosure, the speech translation terminal 100 may communicate with the mobile terminal 300 through the communication component 150, such as a Bluetooth component. After the acquisition of the first speech information, the speech translation terminal 100 may send the first speech information to the mobile communication component 310 of the mobile terminal 300 through the BLE protocol, and the first speech information may be preprocessed by the mobile processor 320 of the mobile terminal 300. After the mobile processor 320 preprocesses the first speech information, the preprocessed first speech information may be sent to the server 200 through the mobile communication component 310. Upon reception of the preprocessed first speech information, the server 200 may translate the preprocessed first speech information by the processor 220, to obtain the second speech information. Then, the server 200 may send the second speech information to the mobile terminal 300 by the transmitter 230, and the mobile communication component 310 in the mobile terminal 300 may send the second speech information to the speech translation terminal 100 according to the BLE protocol, and correspondingly, the speech translation terminal 100 may play the first speech information by the speaker 140 upon the reception of the second speech information.

Specifically, the processor 220 of the server 200 may translate the preprocessed first speech information into the second speech information according to the translation setting of the mobile terminal 300. The translation setting may be determined by translation setting information input by the user.

In the embodiment of the present disclosure, the user may set the translation setting information in the mobile terminal. For example, the user may set the translation setting information in a translation APP of the mobile terminal. After the translation setting information is set, the mobile terminal may send the translation setting information to the server, and the server may determine, according to the translation setting information set by the user, a corresponding translation setting.

As an alternative implementation, the translation setting information may include settings of mutual translation between the first language and the second language. In this case, the translation setting may include a setting that the first language and the second language are mutually translated into one another. The processor 220 may recognize the language of the preprocessed first speech information, when the language of the preprocessed first speech information is the first language, the processor 220 may translate it into the second speech information of the second language, when the language of the preprocessed first speech information is the second language, the processor 220 may translate it into second speech information of the first language. Thus, the server can automatically recognize the language spoken by the user, and translate it into corresponding speech information of the other language, it is unnecessary to set a corresponding button on the speech translation device 100 to determine the language spoken by the user, thereby simplifying the user's operations, and improving the user experience.

The translation setting may include mutual translation between Chinese and English, mutual translation between Chinese and French, mutual translation between English and German, etc. For example, when the translation setting is the mutual translation between Chinese and English, the first language may be Chinese, and the second language may be English, or the first language may be English, and the second language may be Chinese.

As another alternative implementation, the translation setting information may include settings of translation from the first language to the second language. In this case, the translation setting may include the setting that the first language is translated into the second language, and the processor 220 may translate the preprocessed first speech information into the second speech information of the second language. The translation setting may include translation from Chinese to English, translation from English to Chinese, translation from Chinese to French, translation from Chinese to German, etc. For example, when the translation setting is the translation from Chinese to English, the first language may be Chinese, and the second language may be English.

With the translation system according to embodiments of the present disclosure, first speech information may be acquired by the speech translation terminal when the trigger button is triggered, and the first speech information is sent to the mobile terminal. Then, the mobile terminal may preprocess the first speech information, and send the preprocessed first speech information to the server. The server may translate the preprocessed first speech information into the second speech information according to the translation setting of the mobile terminal, and then send the second speech information to the speech translation terminal through the mobile terminal. After the speech translation terminal receives the second speech information, the speech translation terminal may play the second speech information through the speaker. Thus, there is no need to arrange a corresponding button on the speech translation terminal to determine the language of the first speech information, and the user merely needs to trigger the only trigger button to acquire the first speech information, such that the first speech information can be automatically translated into another language, thereby simplifying the operations of the user, and improving the user experience.

As an alternative implementation, in preprocessing the first speech information, the mobile processor 320 may be configured to perform an integrity check on the first speech information. When the first speech information passes the integrity check, the mobile processor 320 may decode the first speech information. When the first speech information fails the integrity check, the mobile processor 320 may send feedback to the speech translation terminal 100, such that the speech translation terminal 100 resends the first speech information.

In the process of acquiring the speech and generating the speech file, it may be understood that, the speech translation terminal 100 may generate a header, a trailer and the like of the speech file, and the final first speech information sent to the mobile terminal 300 should be complete. When mobile terminal 300 receives the first speech information, the mobile terminal 300 may perform an integrity check on the first speech information to determine whether the first speech information is complete. When the first speech information is not complete, the mobile terminal may send feedback to the speech translation terminal 100, to cause the speech translation terminal 100 to resend the first speech information. When the first speech information is complete, the mobile terminal may decode the first speech information, and send the decoded first speech information to the server 200.

Specifically, the mobile terminal 300 may decode the first speech information based on the speech file format supported by the server 200. For example, for a Microsoft server, its supported speech file format is a MP3 format, the first speech information may be decoded into the speech file of the MP3 format, and the decoded first speech information may be sent to the Microsoft server, such that the Microsoft server may translate the first speech information according to the its supported format, to obtain the second speech information.

In the embodiment of the present disclosure, by decoding the first speech information according to the speech file format supported by the server, the server can perform normal translation of the first speech information.

As an alternative implementation, in order to guarantee the signal quality of the first speech information, reduce network resource occupation, and improve the translation efficiency, the controller 110 may further compress and packetize the processed first speech information after the first speech information is acquired.

The communication component 150 may be configured to send the compressed and packetized first speech information to the mobile terminal 300. The mobile terminal 300 may preprocess the compressed and packetized first speech information, and then send the preprocessed first speech information to the server 200, such that the server 200 may recognize the preprocessed first speech information to acquire the language of the preprocessed first speech information, and translate, according to the translation setting of the mobile terminal and the language of the preprocessed first speech information, the preprocessed first speech information to obtain the second speech information.

The controller 110 is further configured to acquire the second speech information sent by the server 200, and depacketize and decompress the second speech information.

The speaker 140 is configured to play the depacketized and decompressed second speech information.

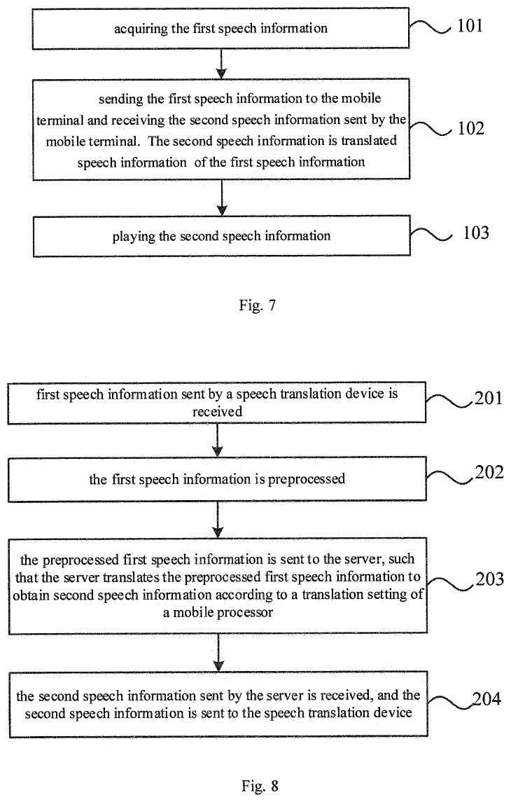

To implement the above embodiments, the present disclosure further provides a translation method. FIG. 7 is a flow chart of a translation method according to embodiment seven of the present disclosure. The translation method may be applicable to the above speech translation terminal, and the speech translation terminal is configured to communicate with a mobile terminal. As illustrated in FIG. 7, the translation method may include the following steps.

At block 101, first speech information is acquired.

In the embodiment of the present disclosure, the speech translation terminal may be provided with a trigger button, and the user may input speech data by triggering the trigger button. When the speech translation terminal detects, by listening, that the trigger button is triggered by the user, it may acquire first speech information through the microphone set.

The microphone set may include at least two microphones. For example, when the microphone set includes two microphones, one may be configured to acquire speech data input by the user, and the other may be configured to acquire noise data. For example, a microphone may be arranged on the front side of the speech translation terminal, and configured to acquire the speech data input by the user. It should be understood that, in addition to normal acquisition of user's speech data, there may also be environmental noise around the microphone. The other microphone may be arranged on the rear side of the speech translation terminal, and configured to acquire the noise data. It should be understood that, the noise data may also contain a small portion of speech data input by the user. The microphone set may subtract and amplify the speech data and the noise data, thereby obtaining the first speech information. Thus, the first speech information is obtained by noise reduction, the signal quality of the first speech information can be improved, such that the translation accuracy may be increased in subsequent steps of obtaining second speech information through translation.

At block 102, the first speech information is sent to the mobile terminal, and the second speech information sent by the mobile terminal is received. The second speech information is speech information translated from the first speech information.

In the embodiment of the present disclosure, the speech translation terminal may communicate with the mobile terminal through the communication component such as a Bluetooth component. After acquisition of the first speech information, the speech translation terminal may send the first speech information to the mobile terminal through a BLE protocol, and then the mobile terminal may send the first speech information to the server. Upon reception of the first speech information, the server may translate the first speech information to obtain the second speech information. After the server obtains the second speech information through translation, it may send the second speech information to the speech translation terminal through the mobile terminal.

Specifically, the server may translate the first speech information into the second speech information according to a translation setting of the mobile terminal. The translation setting may be determined based on translation setting information input by the user.

In the embodiment of the present disclosure, the user may set the translation setting information in the mobile terminal. For example, the user may set the translation setting information in a translation APP in the mobile terminal. After the translation setting information is set by the user, the mobile terminal may send it to the server, and the server may determine, according to the translation setting information set by the user, a corresponding translation setting.

As an alternative implementation, the translation setting information may include settings of mutual translation between the first language and the second language. In this case, the translation setting may include a setting that the first language and the second language are mutually translated into one another. The server may recognize the language of the first speech information, when the language of the first speech information is the first language, the server may translate it into second speech information of the second language, and when the language of the first speech information is the second language, the server may translate it into second speech information of the first language. Thus, the server can automatically recognize the language spoken by the user, and translate it into corresponding speech information of the other language, it is unnecessary to set a corresponding button on the speech translation device 100 to determine the language spoken by the user, thereby simplifying the user's operations, and improving the user experience.

The translation setting may include mutual translation between Chinese and English, mutual translation between Chinese and French, mutual translation between English and German, etc. For example, when the translation setting is the mutual translation between Chinese and English, the first language may be Chinese, and the second language may be English, or the first language may be English, and the second language may be Chinese.

As another alternative implementation, the translation setting information may include settings of translation from the first language to the second language. In this case, the translation setting may include the setting that the first language is translated into the second language. The server may translate the first speech information into the second speech information of the second language.

The translation setting may include translation from Chinese to English, translation from English to Chinese, translation from Chinese to French, translation from Chinese to German, etc. For example, when the translation setting is the translation from Chinese to English, the first language may be Chinese, and the second language may be English.

At block 103, the second speech information is played.

In the embodiment of the present disclosure, after the speech translation terminal receives the second speech information, it may play the second speech information by the speaker.

With the translation method according to embodiments of the present disclosure, first speech information may be acquired through the speech translation terminal, and the first speech information may be sent to the mobile terminal, and second speech information sent by the mobile terminal may be received. The first speech information may be transmitted to the server through the mobile terminal, and the second speech information may be obtained through the translation of the server, and the server may send the second speech information to the speech translation terminal through the mobile terminal. Then, the speech translation terminal may play the second speech information. Thus, the first speech information may be automatically translated into another language.

As an alternative implementation, the first speech information received by the server is preprocessed by the mobile terminal. For example, the second speech information may be obtained by acts of preprocessing, by the mobile terminal, the first speech information; sending, by the mobile terminal, the preprocessed first speech information to the server; and translating, by the server, the preprocessed first speech information according to the translation setting of the mobile terminal.

In the process of acquiring the speech and generating the speech file, it may be understood that, the speech translation terminal may generate a header, a trailer and the like of the speech file, and the final first speech information sent to the mobile terminal should be complete. When mobile terminal receives the first speech information, the mobile terminal may perform an integrity check on the first speech information to determine whether the first speech information is complete. When the first speech information is not complete, the mobile terminal may send feedback to the speech translation terminal, to cause the speech translation terminal to resend the first speech information. When the first speech information is complete, the mobile terminal may decode the first speech information, and send the decoded first speech information to the server.

Specifically, the mobile terminal may decode the first speech information based on the speech file format supported by the server. For example, for a Microsoft server, its supported speech file format is a MP3 format, the first speech information may be decoded into the speech file of the MP3 format, and the decoded first speech information may be sent to the Microsoft server, such that the Microsoft server translates the first speech information according to the its supported format, to obtain the second speech information.

In the embodiment of the present disclosure, by decoding the first speech information according to the speech file format supported by the server, the server can perform normal translation of the first speech information.

As an alternative implementation, to guarantee the quality of the first speech information, reduce network resource occupation, and improve the translation efficiency, after the microphone set acquires the first speech information, the first speech information may be compressed and packetized.

Correspondingly, block 102 may include sending the compressed and packetized first speech information to the mobile terminal. Upon the reception of the compressed and packetized first speech information, the mobile terminal may preprocess it, and send the preprocessed first speech information to the server, such that the server may recognize the preprocessed first speech information to acquire the language of the preprocessed first speech information, and translate, according to the translation setting of the mobile terminal and the language of the preprocessed first speech information, the preprocessed first speech information to generate the second speech information.

After the server obtains the second speech information through translation, it may send the second speech information to the speech translation terminal through the mobile terminal. Correspondingly, after reception of the second speech information, the speech translation terminal may depacketize and decompress the second speech information, and play the depacketized and decompressed second speech information.

To implement the above embodiments, the present disclosure further provides a translation method. FIG. 8 is a flow chart of a translation method according to embodiment eight of the present disclosure. The translation method may be applicable to the mobile terminal described above, and configured to communicate with a speech translation terminal and a server. As illustrated in FIG. 8, the translation method may include the following steps.

At block 201, first speech information sent by the speech translation device is received.

In the embodiment of the present disclosure, after acquisition of the first speech information, the speech translation terminal may send the first speech information to the mobile terminal through the communication component. Correspondingly, the mobile terminal may receive the first speech information sent by the speech translation device.

At block 202, the first speech information is preprocessed.

In the embodiment of the present disclosure, upon the reception of the first speech information, the mobile terminal may preprocess the first speech information to obtain the preprocessed first speech information.

In the process of acquiring the speech and generating the speech file, it may be understood that, the speech translation terminal may generate a header, a trailer and the like of the speech file, and the final first speech information sent to the mobile terminal should be complete. When mobile terminal receives the first speech information, the mobile terminal may perform an integrity check on the first speech information to determine whether the first speech information is complete. When the first speech information is not complete, the mobile terminal may send feedback to the speech translation terminal, to cause the speech translation terminal to resend the first speech information. When the first speech information is complete, the mobile terminal may decode the first speech information, and send the decoded first speech information to the server.

Specifically, the mobile terminal may decode the first speech information based on the speech file format supported by the server. For example, for a Microsoft server, its supported speech file format is a MP3 format, the first speech information may be decoded into the speech file of the MP3 format, and the decoded first speech information may be sent to the Microsoft server, such that the Microsoft server translates the first speech information according to the its supported format, to obtain the second speech information.

In the embodiment of the present disclosure, by decoding the first speech information according to the speech file format supported by the server, the server can perform normal translation of the first speech information.

At block 203, the preprocessed first speech information is sent to the server, such that the server translates the preprocessed first speech information to obtain second speech information according to a translation setting of the mobile processor.

In the embodiment of the present disclosure, the translation setting may be determined based on translation setting information input by the user. Specifically, the user may set the translation setting information in the mobile terminal. For example, the user may set the translation setting information in a translation APP in the mobile terminal. After the translation setting information is set by the user, the mobile terminal may send it to the server, and the server may determine, according to the translation setting information set by the user, a corresponding translation setting.

As an alternative implementation, the translation setting information may include settings of mutual translation between the first language and the second language. In this case, the translation setting may include a setting that the first language and the second language are mutually translated into one another. The translation setting may include mutual translation between Chinese and English, mutual translation between Chinese and French, mutual translation between English and German, etc. For example, when the translation setting is the mutual translation between Chinese and English, the first language may be Chinese, and the second language may be English, or the first language may be English, and the second language may be Chinese.

In the embodiment of the present disclosure, after the first speech information is preprocessed, the mobile terminal may send the preprocessed first speech information to the server, such that the server may recognize the language of the preprocessed first speech information. When the language of the preprocessed first speech information is the first language, the server may translate it into the second speech information of the second language, and when the language of the preprocessed first speech information is the second language, the server may translate it into second speech information of the first language. Thus, the server can automatically recognize the language spoken by the user, and translate it into corresponding speech information of the other language. Therefore, it is unnecessary to set a corresponding button on the speech translation terminal to determine the language spoken by the user, thereby simplifying the user's operations, and improving the user experience.

As another alternative implementation, the translation setting information may include settings of translation from the first language to the second language. In this case, the translation setting may include the setting that the first language is translated into the second language. The translation setting may include translation from Chinese to English, translation from English to Chinese, translation from Chinese to French, translation from Chinese to German, etc. For example, when the translation setting is the translation from Chinese to English, the first language may be Chinese, and the second language may be English.

In the embodiment of the present disclosure, after the first speech information is preprocessed, the mobile terminal may send the preprocessed first speech information to the server, such that the server may translate the preprocessed first speech information into the second speech information of the second language.

At block 204, the second speech information sent by the server is received, and the second speech information is sent to the speech translation device.

In the embodiment of the present disclosure, when the server obtains the second speech information through translation, it may send the second speech information to the mobile terminal, and the mobile terminal may send the second speech information to the speech translation terminal. Correspondingly, the speech translation terminal may play the second speech information upon the reception of the second speech information.

With the translation method according to the embodiment of the present disclosure, first speech information is received through the mobile terminal, and the first speech information is preprocessed, and then the preprocessed first speech information is sent to server, such that the server translates the first speech information into second speech information according to the translation setting of the mobile terminal. Then, the second speech information is sent to the mobile terminal, and upon the reception of the second speech information, the mobile terminal sends it to the speech translation device, such that the speech translation device plays the second speech information. Thus, the first speech information may be automatically translated into another language.

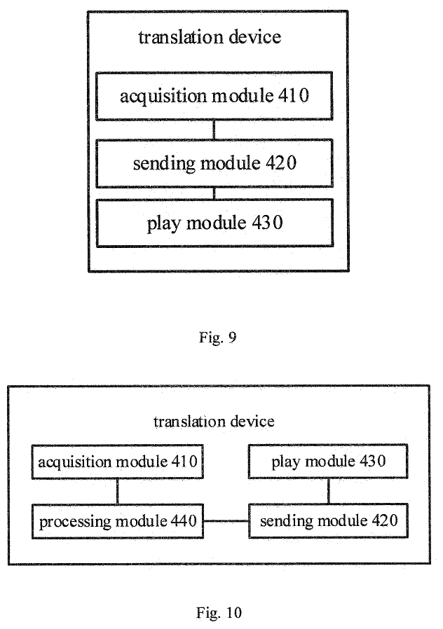

To implement the above embodiments, the present disclosure further provides a translation device. FIG. 9 is a schematic diagram of a translation device according to embodiment nine of the present disclosure. As illustrated in FIG. 9, the translation device includes: an acquisition module 410, a sending module 420, and a play module 430.

The acquisition module 410 is configured to acquire first speech information.

As an alternative implementation, the acquisition module 410 may further be configured to: acquire speech data input by the user and noise data; and subtract and amplify the speech data and the noise data to obtain the first speech information.

The sending module 420 is configured to send the first speech information to a mobile terminal, and receive second speech information sent by the mobile terminal. The second speech information is speech information translated from the first speech information.

As an alternative implementation, the second speech information may be obtained by acts of preprocessing, by the mobile terminal, the first speech information; sending, by the mobile terminal, the preprocessed first speech information to the server; and translating, by the server, the preprocessed first speech information according to the translation setting of the mobile terminal

The play module 430 is configured to play the second speech information.

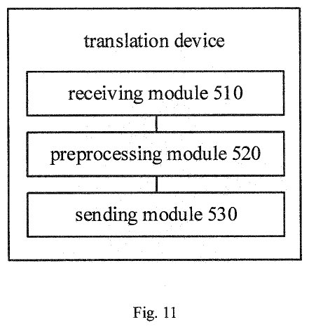

Furthermore, as an alternative implementation of the embodiment of the present disclosure, as illustrated in FIG. 10, FIG. 10 is a block diagram of a translation device according to embodiment ten of the present disclosure, on the basis of embodiments illustrated in FIG. 9, the translation device further includes a processing module 440.

The processing module 440 is configured to compress and packetize the first speech information after the first speech information is acquired.

The sending module 420 is further configured to send the compressed and packetized first speech information to the mobile terminal, such that the mobile terminal preprocesses the compressed and packetized first speech information, and sends the preprocessed first speech information to the server, to cause the server to translate, according to the translation setting of the mobile terminal, the preprocessed first speech information to obtain the second speech information.

The play module 430 is further configured to depacketize and decompress the second speech information, and play the depacketized and decompressed second speech information.

It should be noted that, the foregoing explanations of embodiments of the translation method may also be applicable to the translation device in the embodiment, and details are not described herein again.

With the translation device according to the embodiment of the present disclosure, first speech information is acquired through the speech translation terminal, the first speech information is sent to the mobile terminal, and second speech information sent by the mobile terminal is received. The first speech information is transmitted to the server through the mobile terminal, and the second speech information is obtained through the translation of the server, and the server sends the second speech information to the speech translation terminal through the mobile terminal. Then, the speech translation terminal plays the second speech information. Thus, the first speech information may be automatically translated into another language.

To implement the above embodiments, the present disclosure further provides a translation device. FIG. 11 is a schematic diagram of a translation device according to embodiment eleven of the present disclosure. As illustrated in FIG. 11, the translation device includes a receiving module 510, a preprocessing module 520, and a sending module 530.

The receiving module 510 is configured to receive first speech information sent by the speech translation device. The preprocessing module 520 is configured to preprocess the first speech information.

As an alternative implementation, the preprocessing module 520 is further configured to: perform an integrity check on the first speech information; when the first speech information passes the integrity check, decode the first speech information; and when the first speech information fails the integrity check, send feedback to the speech translation terminal, to cause the speech translation terminal to resend the first speech information.

The sending module 530 is configured to send the preprocessed first speech message to the server, such that the server translates the preprocessed first speech information to obtain the second speech information according to the translation setting of the mobile processor.

As an alternative implementation, the translation setting information includes settings of mutual translation between the first language and the second language, or settings of translation from the first language to the second language.

The receiving module 510 is further configured to receive the second speech information sent by the server. The sending module 530 is further configured to send the second speech information to the speech translation device.

It should be noted that, the foregoing explanations of embodiments of the translation method may also be applicable to the translation device in the embodiment, and details are not described herein again.

With the translation device according to the embodiment of the present disclosure, first speech information is received through the mobile terminal, and the first speech information is preprocessed, and the preprocessed first speech information is sent to server, such that the server translates the first speech information into second speech information according to the translation setting of the mobile terminal. Then, the second speech information is sent to the mobile terminal, and mobile terminal may send the second speech information to a speech translation device upon the reception of the second speech information, such that the speech translation device plays the second speech information. Thus, the first speech information may be automatically translated into another language.

To implement the above embodiments, the present disclosure further provides a speech translation terminal, including a memory, a processor and a computer program stored in the memory and executable by the processor. The computer program, when executed by the processor, causes the translation method according to embodiments of FIG. 7 of the present disclosure to be implemented.

To implement the above embodiments, the present disclosure further provides a server including a memory, a processor and a computer program stored in the memory and executable by the processor. The computer program, when executed by the processor, causes the translation method according to embodiments of FIG. 8 of the present disclosure to be implemented.

To implement the above embodiments, the present disclosure further provides a computer readable storage medium having stored thereon a computer program that, when executed by a processor, causes the translation method according to embodiments of FIG. 7 or FIG. 8 of the present disclosure to be implemented.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. In this specification, exemplary descriptions of aforesaid terms are not necessarily referring to the same embodiment or example. Furthermore, the particular features, structures, materials, or characteristics may be combined in any suitable manner in one or more embodiments or examples. In addition, without conflicting, various embodiments or examples or features of various embodiments or examples described in the present specification may be combined by those skilled in the art.

It should be noted that, in description of the present disclosure, terms such as “first” and “second” are used herein for purposes of description and are not intended to indicate or imply relative importance or significance. In addition, in the description of the present disclosure, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which the functions may not be performed in sequences, including a sequence that related functions are performed in a substantially simultaneous or a reverse manner, illustrated or discussed herein, which should be understood by persons of ordinary skill in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

Each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc. Although explanatory embodiments have been shown and described, it would be appreciated by persons of ordinary skill in the art that the above embodiments cannot be construed to limit the present disclosure, and changes, alternatives, and modifications can be made in the embodiments without departing from scope of the present disclosure.

What is claimed is:

1. A speech translation terminal, comprising a controller, one trigger button, a microphone set, a speaker, and a communication component;
the trigger button being electrically coupled to the controller;
the microphone set being electrically coupled to the controller, and configured to acquire first speech information after the trigger button is triggered;
the speaker being electrically coupled to the controller, and configured to play second speech information under control of the controller, wherein the second speech information is speech information translated from the first speech information; and
the controller being electrically coupled to the communication component, and configured to control the communication component to send the first speech information to a mobile terminal, and to control the communication component to receive the second speech information sent by the mobile terminal.

2. The speech translation terminal according to claim 1, wherein the microphone set comprises two microphones, one microphone is configured to acquire speech data input by a user, and the other microphone is configured to acquire noise data,
the microphone set is further configured to:
subtract and amplify the speech data and the noise data to obtain the first speech information.

3. The speech translation terminal according to claim 1, wherein the controller is further configured to:
receive the first speech information acquired by the microphone set, and compress and packetize the first speech information;
control the communication component to send compressed and packetized first speech information to the mobile terminal, and control the communication component to receive the second speech information sent by the mobile terminal;
depacketize and decompress the second speech information; and
control the speaker to play the depacketized and decompressed second speech information.

4. A mobile terminal, comprising a mobile communication component, and a mobile processor;
the mobile communication component being electrically coupled to the mobile processor, and configured to communicate with a speech translation terminal and a server;
the mobile communication component being configured to receive first speech information sent by the speech translation terminal, and send the first speech information preprocessed by the mobile processor to the server, such that the server, according to a translation setting of the mobile processor, translates the preprocessed first speech information to obtain second speech information;
the mobile communication component being further configured to receive the second speech information sent by the server, and send the second speech information to the speech translation terminal;
the mobile processor being configured to preprocess the first speech information; and
the mobile processor being further configured to generate translation setting information, and send the translation setting information to the server through the mobile communication component, such that the server determines the translation setting according to the translation setting information, and translates the preprocessed first speech information based on the translation setting to obtain the second speech information.

5. The mobile terminal according to claim 4, wherein in preprocessing the first speech information, the mobile processor is configured to:
perform an integrity check on the first speech information;
decode the first speech information when the first speech information passes the integrity check; and
send feedback to the speech translation terminal to cause the speech translation terminal to resend the first speech information, when the first speech information fails the integrity check.

6. The mobile terminal according to claim 4, wherein the translation setting comprises:
settings of mutual translation between a first language and a second language; or
settings of translation from the first language to the second language.

7. A translation method, applicable to a speech translation terminal, wherein the speech translation terminal is configured to communicate with a mobile terminal, the method comprises:
acquiring first speech information;
sending the first speech information to the mobile terminal, and receiving second speech information sent by the mobile terminal; wherein the second speech information is speech information translated from the first speech information; and
playing the second speech information.

8. The translation method according to claim 7, wherein the second speech information is obtained by acts of:
preprocessing, by the mobile terminal, the first speech information;
sending, by the mobile terminal, the preprocessed first speech information to a server; and
translating, by the server, the preprocessed first speech information according to a translation setting of the mobile terminal.

9. The translation method according to claim 7, wherein acquiring the first speech information comprises:
acquiring speech data input by a user and noise data; and
subtracting and amplifying the speech data and the noise data, to obtain the first speech information.

10. The translation method according to claim 7, wherein the method further comprises:
compressing and packetizing the first speech information,
wherein sending the first speech information to the mobile terminal comprises:
sending compressed and packetized first speech information to the mobile terminal, such that the mobile terminal preprocesses the compressed and packetized first speech information, and sends the preprocessed first speech information to a server, to cause the server to translate the preprocessed first speech information to obtain the second speech information according to a translation setting of the mobile terminal.

11. The translation method according to claim 7, wherein playing the second speech information comprises:
depacketizing and decompressing the second speech information; and
playing the depacketized and decompressed second speech information.

12. The translation method according to claim 8, wherein the first speech information is preprocessed by the mobile terminal by acts of:
performing an integrity check on the first speech information;
decoding the first speech information when the first speech information passes the integrity check; and
sending feedback to the speech translation terminal to cause the speech translation terminal to resend the first speech information, when the first speech information fails the integrity check.

13. The translation method according to claim 10, wherein the translation setting comprises: settings of mutual translation between a first language and a second language, or settings of translation from the first language to the second language.
